(19) United States
(12) Patent Application Publication
(10) Pub. No.: US 2009/0100103 A1
(43) Pub. Date: Apr. 16, 2009

(54) RECORDING MEDIUM HAVING INFORMATION COLLECTING PROGRAM RECORDED THEREON, INFORMATION COLLECTING DEVICE, AND INFORMATION COLLECTING METHOD

(75) Inventor: Takashi Yoshioka, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/246,985

(22) Filed: Oct. 7, 2008

(30) Foreign Application Priority Data
Oct. 11, 2007 (JP) 2007-265666

(51) Int. Cl. G06F 7/00; G06F 17/30

(52) U.S. Cl. 707/104.1; 707/100; 707/10; 707/E17.005; 707/E17.032; 707/E17.044

(57) ABSTRACT

An information accepting unit accepts information provided from an information provider. A provided information management database associates the provided information with the information provider and manages the provided information associated with the information provider. An analysis unit analyzes the provided information managed by the provided information management database, and an analysis information management database associates an analysis result of the analysis unit with the provided information and manages the analysis information. An output unit outputs the analysis information managed by the analysis information management database. An evaluation information accepting unit accepts evaluation information of the analysis information outputted from the output unit; and an evaluation unit calculates evaluation information of the information provider, based on the first evaluation information accepted by the evaluation information accepting unit.

### TECHNICAL FIELD

The present invention relates to an information collecting program, an information collecting device, and an information collecting method which collects information from an unspecified number of information providers and evaluates an information provider which has provided information, for marketing research to research market needs.

### SUMMARY

An information collecting device includes:

a provided information accepting unit which accepts provided information provided from an information provider, as electronic data;

a provided information management database which associates the provided information with the information provider and manages the provided information associated with the information provider;

an analysis unit which analyzes the provided information managed by the provided information management database;

an analysis information management database which associates an analysis result of the analysis unit with the provided information and manages the analysis information associated with the provided information;

an output unit which outputs the analysis information managed by the analysis information management database, as electronic data;

an evaluation information accepting unit which accepts first evaluation information that is evaluation information of the analysis information outputted from the output unit, as electronic data; and an evaluation unit which calculates second evaluation information that is evaluation information of the information provider, based on the first evaluation information accepted by the evaluation information accepting unit.

### BRIEF DESCRIPTION OF THE DRAWINGS

FIG. 1 is a diagram which shows an outline of a marketing research process performed by an information collecting device according to an embodiment;

FIG. 2 is a block diagram which shows a configuration of the information collecting device according to the embodiment;

FIG. 3 is a block diagram which shows configurations of a contractor information management unit, a collected information management unit, an analysis information management unit, and an evaluation unit;

FIG. 4 is a diagram which shows a contractor information management database and a contractor information management table;

FIG. 5 is a diagram which shows a collected information management database and a collected information management table;

FIG. 6 is a diagram which shows an analysis information management database and an analysis information management table;

FIG. 7 is a diagram which shows a probability determination table;

FIG. 8 is a diagram which shows an adoption point determination table;

FIG. 9 is a diagram which shows an evaluation information determination table;

FIG. 10 is a flowchart of an operation of the information collecting device according to the embodiment;

FIG. 11 is a flowchart of an operation of probability determination processing;

FIG. 12 is a diagram which shows a probability determination method;

FIG. 13 is a flowchart of an operation of evaluation information update processing;

FIG. 14 is a diagram which shows an outline of transmission of analysis information and reception of feedback information using electronic signatures; and

FIG. 15 is a block diagram which shows a configuration of an electronic document management system.

### DETAILED DESCRIPTION OF THE EMBODIMENT(S)

Hereinafter, an embodiment of the present technique will be described with reference to the drawings.

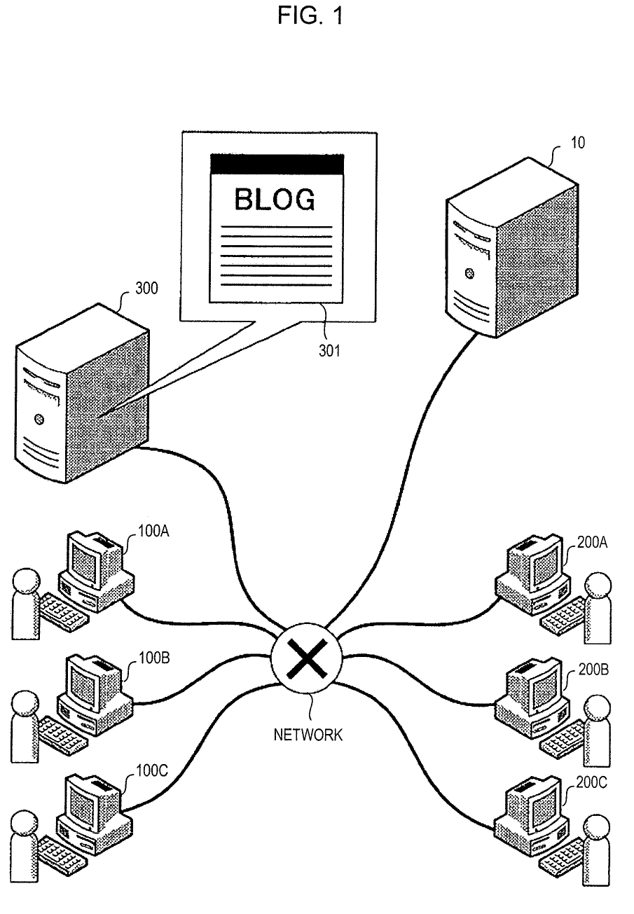

First, an outline of the present embodiment will be described. FIG. 1 is a diagram which shows an outline of a marketing research process performed by an information collecting device according to the present embodiment.

The marketing research according to the present embodiment is performed by: an information collecting device 10 which is placed in a marketing company which performs the marketing research; information providers' PCs 100A to 100C which are a plurality of clients of the information collecting device 10 and are used by information providers who have a contract with the marketing company in advance; and enterprise PCs 200A to 200C which are a plurality of clients of the information collecting device 10 and are used by enterprises to which the marketing company provides an analysis result. The analysis result is found by the marketing company analyzing information collected from the information provider. A blog server 300 provides a blog 301 that is an interface through which the information providers provide information to the marketing company. The information collecting device 10, the information provider PCs 100A to 100C, the enterprise PCs 200A to 200C, and the blog server 300 are connected to the network respectively. The network may be the Internet, an intranet, an extranet, or a wide area network.

The marketing company has an interview or the like with an information provider, thereby checking and screening personal information, using a desired information collecting method. The information can include an experience of using blogs, a history of usage of IT tools, an ability to provide information, and so on with respect to the information provider. The marketing company determines a basic contract price based on the information, and then signs a contract with the information provider. In addition, the marketing company has a contract with an enterprise, and the enterprise pays a fee to the marketing company for the provision of information collected from information providers and the analysis result thereof.

The blog 301 cooperates with the information collecting device 10. An interface for providing information to the information collecting device 10 is provided as one menu item within the blog 301. The blog 301 may be, for example, a portal site or a social network site if it has an interface for providing information to the information collecting device 10 within its pages. However, it is preferably a site in which an individual user is registered therein so that a personal page (or a page customized for individual use) can be easily made. The blog 301 may be provided by the marketing company itself or a different company.

In addition, the blog 301 preferably supports RSS (RDF Site Summary). The RSS structures data such as a header or a summary of a site and describes it in the site, and is mainly used for presenting update information of sites. In a page where RSS information is described, a title, an address, a header, a summary, and an update time of the page can be described. Therefore, using RSS information, a viewer can grasp update information of many web sites effectively in a unified manner.

By using the blog 301, where such RSS information is described, as an interface for collecting information, the marketing company can collect information efficiently. In addition, even if each information provider does not have a blog environment, by providing an attractive easy-to-use blog environment as a service to information providers, the usage rate of the blog environment by information providers can be improved.

It is noted that all information is provided by information providers voluntarily, and the marketing company does not force them to provide information. Information providers do not necessarily use the information providers' PCs 100A to 100C, and, for example, may directly visit the marketing company to provide information.

In accordance with the above described general configuration, information is sent from the information providers' PCs 100A to 100C through the blog 301 to the information collecting device 10. The information collecting device 10 analyzes the sent information and sends the analysis result of the information to the enterprise's PCs 200A to 200C, and the enterprise's PCs 200A to 200C evaluate how beneficial the sent analysis result is and feeds back the evaluation result to the information collecting device 10. The information collecting device 10 assigns point scores to respective information providers based on the evaluation result, and fees corresponding to the point scores are paid to them respectively. In addition, since personal information and provided information of information providers are managed by the marketing company, and information obtained by a plurality of enterprises is just an analysis result, the privacy of information providers is protected when measures to prevent information leakage are taken in by the marketing company.

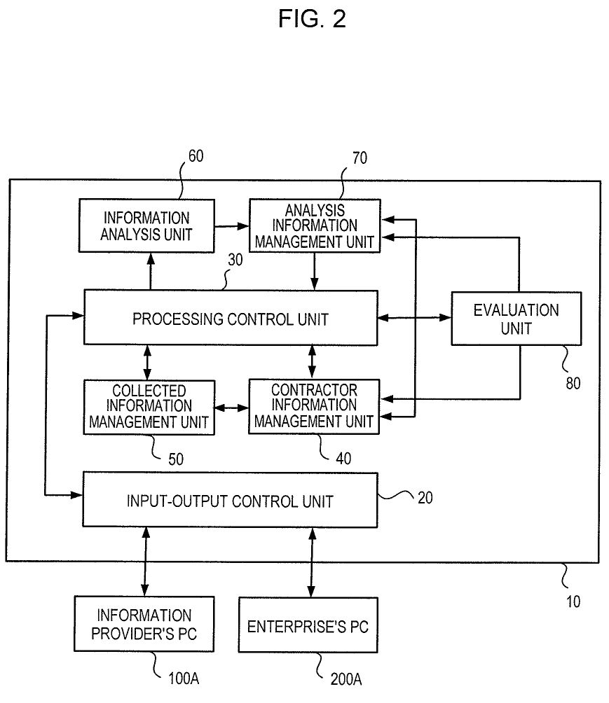

A configuration of the information collecting device according to the present embodiment will next be described. FIG. 2 is a block diagram which shows the configuration of the information collecting device according to the present embodiment. For ease of explanation, in the following description, only the information provider's PC 100A and the enterprise's PC 200A are assumed to be connected to the information collecting device 10.

The information collecting device 10 according to the present embodiment includes an input-output control unit 20 (a provided information accepting unit, an evaluation information accepting unit, an output unit), a processing control unit 30, a contractor information management unit 40 (provided with an information management database), a collected information management unit 50 (provided with an information management database), an information analysis unit 60 (an analysis unit), an analysis information management unit 70, and an evaluation unit 80.

The input-output control unit 20 receives information from the information provider's PC 100A through the blog 301, receives feedback information that is sent back from the enterprise's PC 200A, and sends analysis results to the enterprise's PC 200A.

The processing control unit 30 instructs the contractor information management unit 40, the collected information management unit 50, the information analysis unit 60, the analysis information management unit 70, and the evaluation unit 80 to process information, receives a request from each unit, and sends the received request to the input-output control unit 20.

The contractor information management unit 40 stores and manages personal information of an information provider who is typically an independent contractor. The collected information management unit 50 is requested by the processing control unit 30 to store collected information (provided information) which is provided from the information provider's PC 10A, and stores and manages the collected information.

The information analysis unit 60 receives as an input the collected information managed by the collected information management unit 50 and performs analysis processing on the collected information. The analysis information management unit 70 stores and manages analysis processing result from the information analysis unit 60.

The evaluation unit 80 evaluates respective information providers based on feedback information received by the input-output control unit 20 from the enterprise's PC 200 A, and the information analysis unit 60 sets evaluation information with respect to each information provider based on the evaluation result from the evaluation unit 80.

Manipulation detection information is added to all the information stored in the contractor information management unit 40, collected information management unit 50, and analysis information management unit 70, and all this information is encrypted. Thereby, information including information provider's privacy can be protected from being manipulated and stolen by malicious third parties.

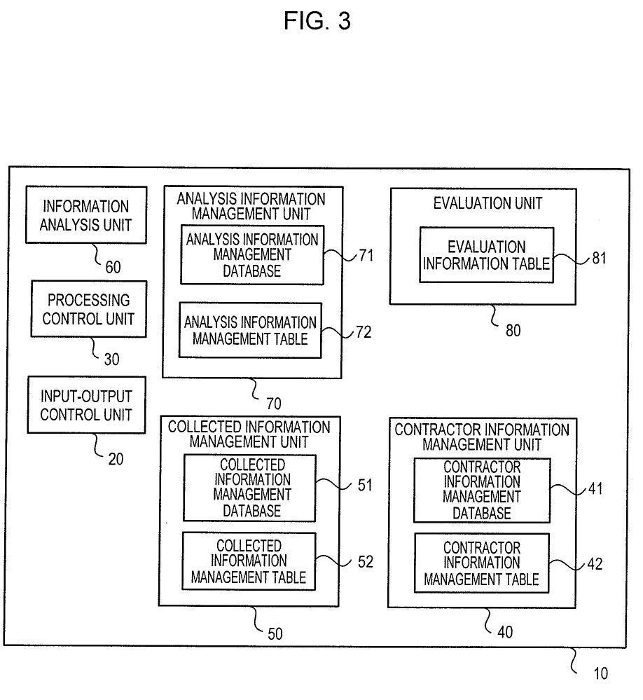

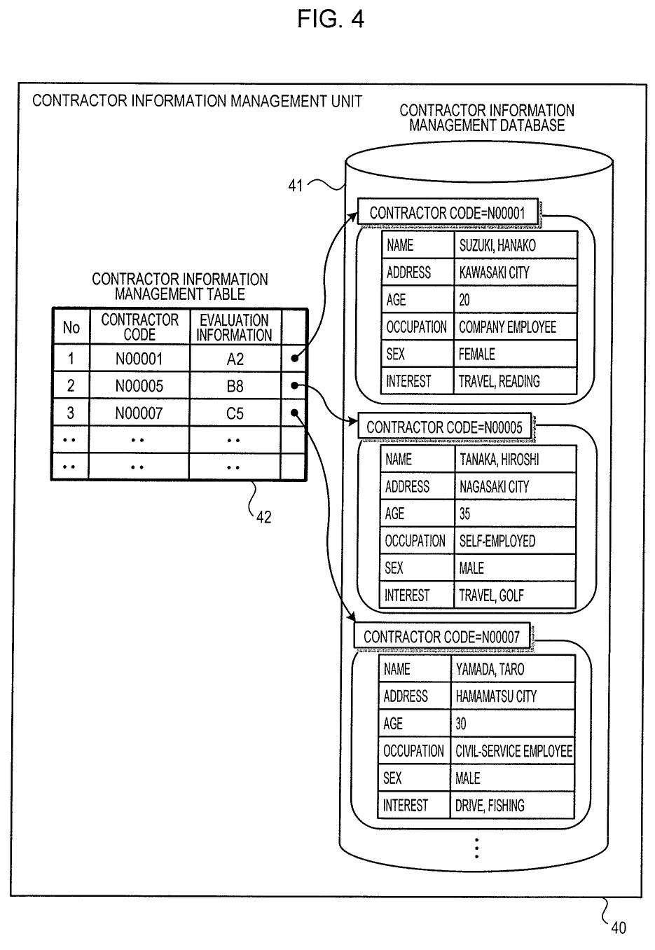

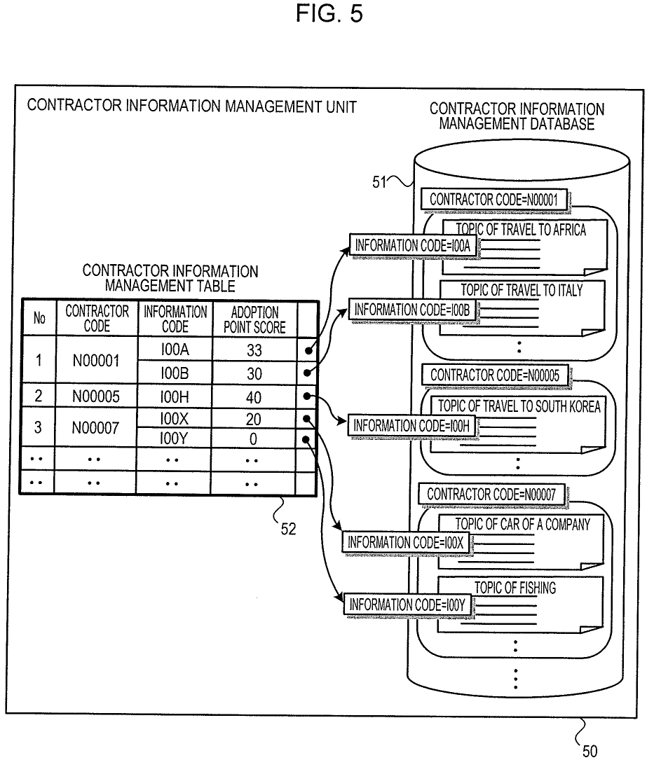

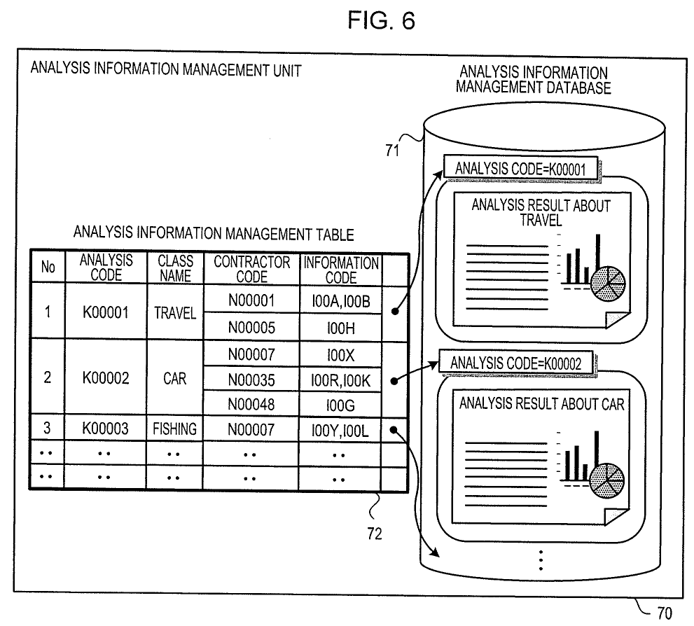

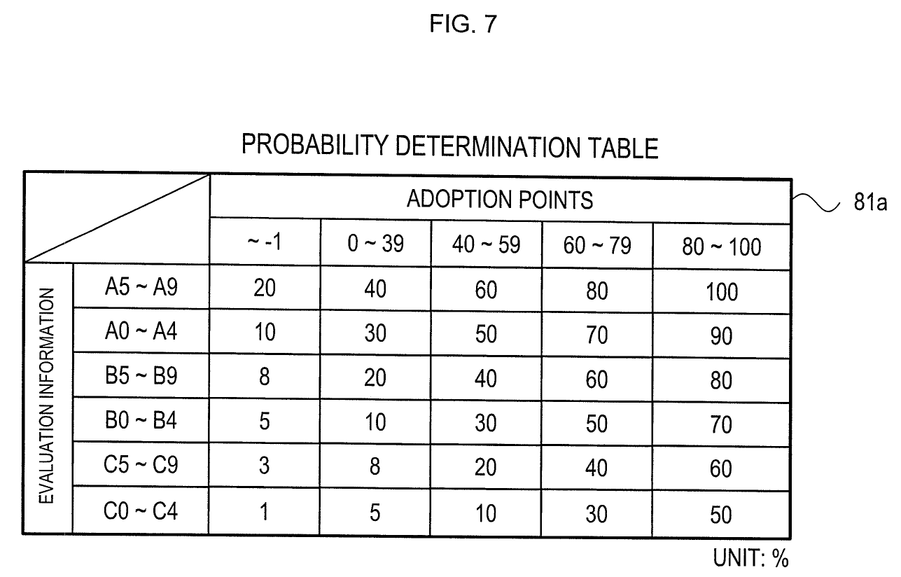

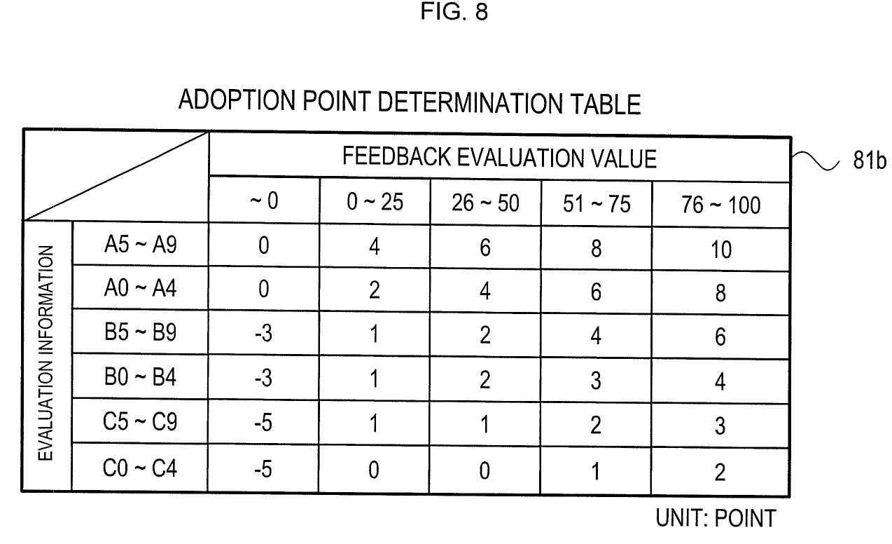

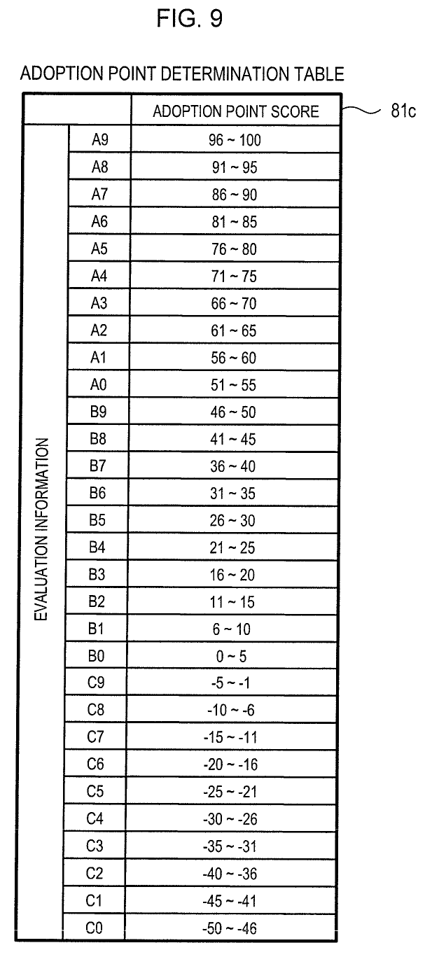

Next, configurations of the contractor information management unit, the collected information management unit, the analysis information management unit, and the evaluation unit will be described with reference to FIGS. 3 to 9. FIG. 3 is a block diagram which shows configurations of the contractor information management unit, the collected information management unit, the analysis information management unit, and the evaluation unit. FIG. 4 is a diagram which shows a contractor information management database and a contractor information management table. FIG. 5 is a diagram which shows a collected information management database and a collected information management table. FIG. 6 is a diagram which shows an analysis information management database and an analysis information management table. FIG. 7 is a diagram which shows a probability determination table. FIG. 8 is a diagram which shows an adoption point determination table. FIG. 9 is a diagram which shows an evaluation information determination table.

The contractor information management unit 40 includes a contractor information management database 41 and a contractor information management table 42. As shown in FIG. 4, the contractor information management database 41 stores and manages providers' personal information such as name, address, age, occupation, sex, and interest thereof, while a contractor code is added as identifiers to respective information providers' personal information. In the contractor management table 42, contractor code and evaluation information (second evaluation information) to be described later are associated and managed.

The collected information management unit 50 includes a collected information management database 51 and a collected information management table 52. As show in FIG. 5, the collected information management database 51 stores and manages information collected from information providers, while contractor code is added to respective information providers, and information code is added as identifiers to respective information. In the collected information management table 52, contractor code, information code, and adoption point scores are associated with one another and managed. The adoption point score is a value which is increased or reduced based on a feedback evaluation value (first evaluation value information) which is included in feedback information from the enterprise's PC 100A, and has an initial value of 0.

The analysis information management unit 70 includes an analysis information management database 71 and an analysis information management table 72. As shown in FIG. 6, the analysis information management database 71 stores and manages analysis information which is a result of analysis by processing of the information analysis unit 60 based on information sent from the information provider's PC 100A, while analysis code is added as identifiers to respective analysis information. In the analysis information management table 72, analysis code, a class name which indicates a genre of information, contractor code, and information code are associated with one another and managed. If there is an enterprise which is a competitor to a certain enterprise to which information is provided, in the analysis information management table 72, analysis information may be managed to be associated with the enterprise to which information is provided. Thereby, provision of information to both sides can be prevented, for example, in a case where the marketing company has a contract with a certain enterprise so that the same information is not provided to an enterprise which is a competitor to the certain enterprise.

The evaluation unit 80 includes an evaluation information management table 81. The evaluation information management table 81 is composed of a probability determination table 81a, an adoption point determination table 81b, and an evaluation information determination table 81c. As shown in FIG. 7, the probability determination table 81a is a table for determining a probability which indicates the degree of certainty of analysis information from evaluation information which is managed in association with contractor code in the contractor information management table 42 and adoption point score (third evaluation information) which is managed in association with information code in the collected information management table 52. As shown in FIG. 8, the adoption point determination table 81b is a table for determining adoption points from evaluation information and a feedback evaluation value. As shown in FIG. 9, the evaluation information determination table 81c is a table for determining evaluation information based on a cumulative adoption point score that is increased or decreased with respect to an information provider.

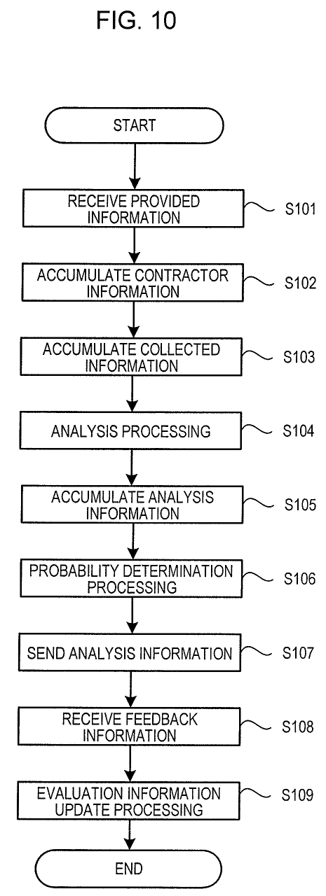

An operation of the information collecting device according to the present embodiment will now be described. FIG. 10 is a flowchart of the operation of the information collecting device according to the present embodiment. In FIG. 10, an information provider who sends information is supposed to send information for the first time after the information provider signs a contract with the marketing company.

First, the input-output control unit 20 of the information collecting device 10 receives collected information including personal information of an information provider through the blog 301 from the information provider's PC 100A (S101, accepting step). The processing control unit 30 acquires the collected information from the input-output control unit 20, and causes the contractor information management unit 40 to store the information providers' personal information such as name, address, age, occupation, sex, and interest thereof associated with contractor code in the contractor information management database 41, and further makes the contractor information management table 42 manage evaluation information associated with contractor code (S102, provided information management step). At this time point, because the information provider has never provided information yet, evaluation information of the information provider is BO corresponding to adoption point score 0.

Then, the processing control unit 30 causes the collected information management unit 50 to store the collected information associated with contractor code and information code in the collected information management database 51, and further makes the collected information management table 52 manage the information code, the contractor code, and the adoption point score which are associated with one another where the information code and contractor code are codes associated with the information code when the collected information has been stored (S103, provided information management step).

Then, the processing control unit 30 causes the information analysis unit 60 to analyze the collected information (S104, analyzing step), and causes the analysis information management unit 70 to store the analysis information based on the analysis processing associated with analysis code in the analysis information management database 71, and further makes the analysis information management table 72 manage the analysis code, a class name, the contractor code, and the information code which are associated with one another (S105, analysis information management step).

When the analysis information is stored and managed in the analysis information management unit 70, the processing control unit 30 causes the evaluation unit 80 to determine a probability indicating the degree of certainty of information about the analysis information according to probability determination processing to be described later (S106, probability calculating step).

Then, the processing control unit 30 acquires the analysis information corresponding to the request of the enterprise including analysis code and classification of the information from the analysis information management unit 70, adds the probability, a time stamp indicating a date of sending information, and an electronic signature described later, to the analysis information, and causes the input-output control unit 20 to send the analysis information to the enterprise's PC 200A (S107, output step).

The enterprise evaluates the received analysis information using an evaluation point score which is a value in the range of 1 to 100, and sends replay information composed of the analysis code sent from the information collecting device 10 and feedback information, from the enterprise's PC 200A to the marketing company.

The input-output control unit 20 receives the replay information sent from the enterprise's PC 200A (S108, evaluation information accepting step). The processing control unit 30 acquires the reply information from the input-output control unit 20, and causes the evaluation unit 80 to execute evaluation information update processing to be described later (S109, evaluation step).

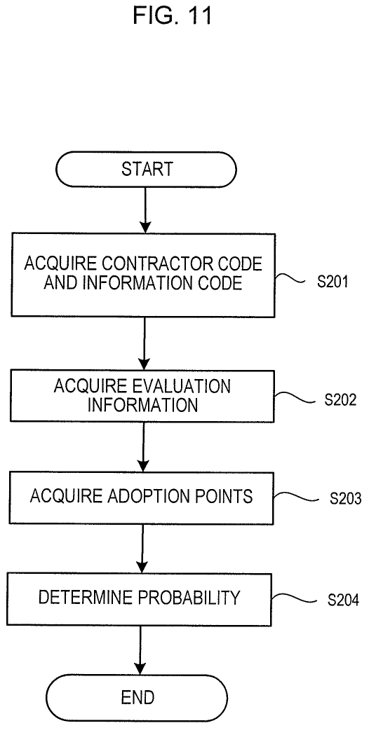

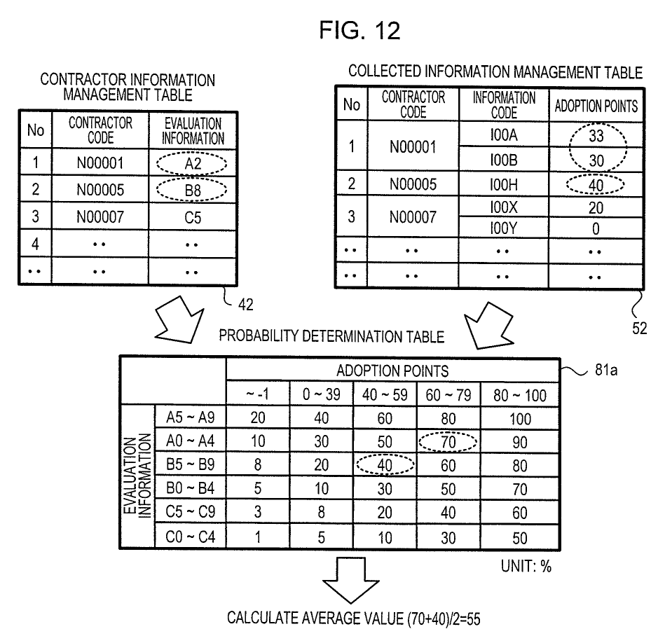

Next, probability determination processing will be described. FIG. 11 is a flowchart of an operation of the probability determination processing, and FIG. 12 is a diagram which shows a probability determination method.

First, from the analysis information management table 72 of the analysis information management unit 70, the evaluation unit 80 acquires all information codes corresponding to analysis code of analysis information and contractor code of an information provider which has provided collected information corresponding to the information code (S201).

Upon receiving the information code and the contractor code, the evaluation unit 80 acquires evaluation information of the information provider based on the contractor code from the contractor information management table 42 of the contractor information management unit 40 (S202), and acquires an adoption point score based on the information code from the collected information management table 52 of the collected information management unit 50 (S203).

The evaluation unit 80 determines a probability based on the acquired adoption point score with reference to the probability determination table 81a (S204). Specifically, as shown in FIG. 12, for example, in a case where analysis information having analysis code of N00001 is sent to the enterprise's PC 200A, probability of 70% is calculated from the sum of scores of information codes I00A and I00B corresponding to N00001, and evaluation information A2 of the information provider of the collected information. Similarly, probability of 40% is calculated from 40 points adoption score of I00H and evaluation information B8 of the information provider of the collected information. Then, an average of these probabilities is calculated as the probability of the analysis information N0001.

As described above, various kinds of information are associated and managed by the tables, so that it is possible to grasp which information provider provides what kind of information. In addition, an adoption point score is assigned to collected information and evaluation information is assigned to each information provider according to the adoption point score, and the beneficialness of information from each information provider can thereby be evaluated. Furthermore, a compensation corresponding to the evaluation is paid to an information provider so that the information provider is motivated to provide more beneficial information. In addition, since a probability of analysis information which indicates the degree of certainty of the information is calculated, a reliability of the analysis information can be provided to an enterprise.

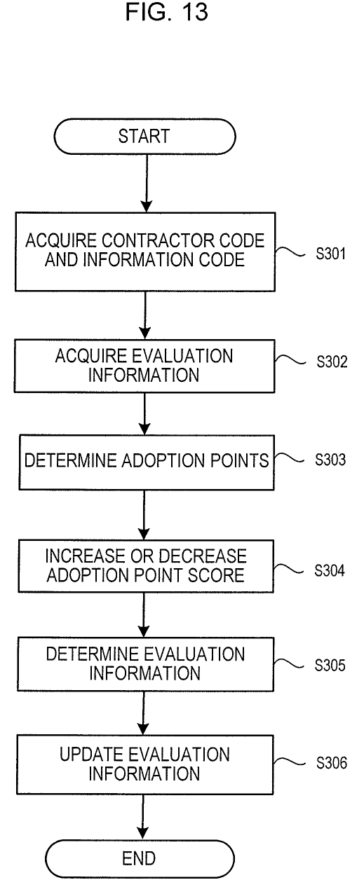

Next, evaluation information update processing will be described. FIG. 13 is a flowchart of an operation of the evaluation information update processing. In FIG. 13, the information collecting device is assumed to have already received replay information.

First, the evaluation unit 80 acquires contractor code and information code from the analysis information management table 72 of the analysis information management unit 70 using analysis code of the replay information as an argument (S301), and further acquires evaluation information from the contractor information management table 42 of the contractor information management unit 40 using the contractor code acquired from the analysis information management table 72 as an argument (S302).

Upon acquiring the evaluation information of the information provider, the evaluation unit 80 determines adoption points based on the acquired evaluation information and feedback information with reference to the adoption point determination table 81b (S303). For example, if evaluation information of an information provider is A2 and feedback information of analysis information based on collected information of the information provider is 57, the corresponding adoption points are 6 points.

Then, the evaluation unit 80 increases or decreases by the points the score of the collected information on which the analysis information is based (S304). Specifically, though the processing control unit 30, the evaluation unit 80 increases or decreases the adoption point score which corresponds to relevant information code in the collected information management table 52 of the collected information management unit 50. For example, in a case where analysis information is based on collected information 1 and collected information 2 of an information provider, evaluation points based on evaluation of analysis information are added with respect to both of the collected information 1 and the collected information 2.

When the adoption point score is updated, the evaluation unit 80 determines evaluation information based on the adoption point score which is a sum of all adoption points of collected information provided by the information provider, with reference to the evaluation information determination table 81c (S305), and updates evaluation information of the information provider in the contractor information management table 42 of the contractor information management unit 40 (S306).

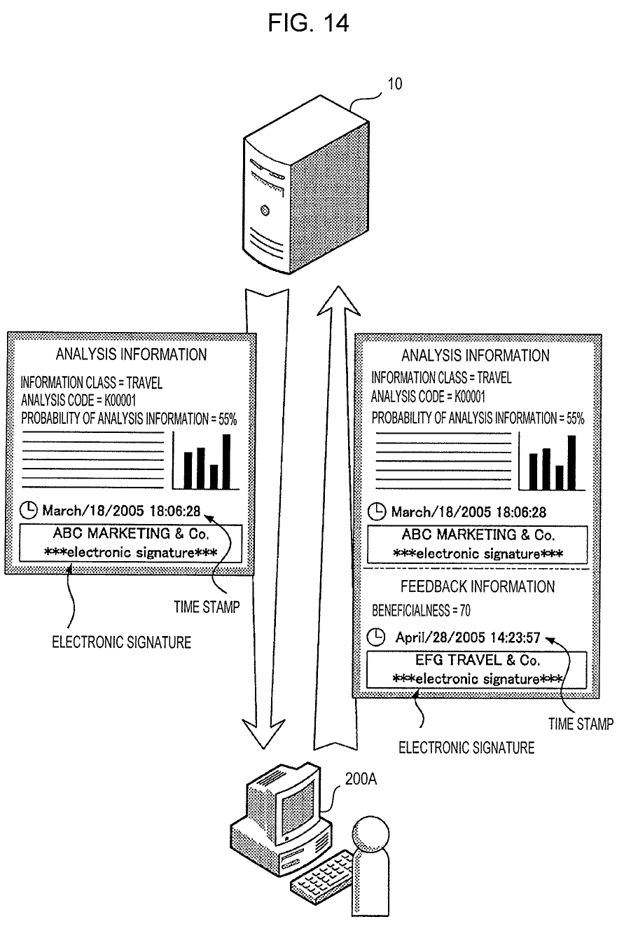

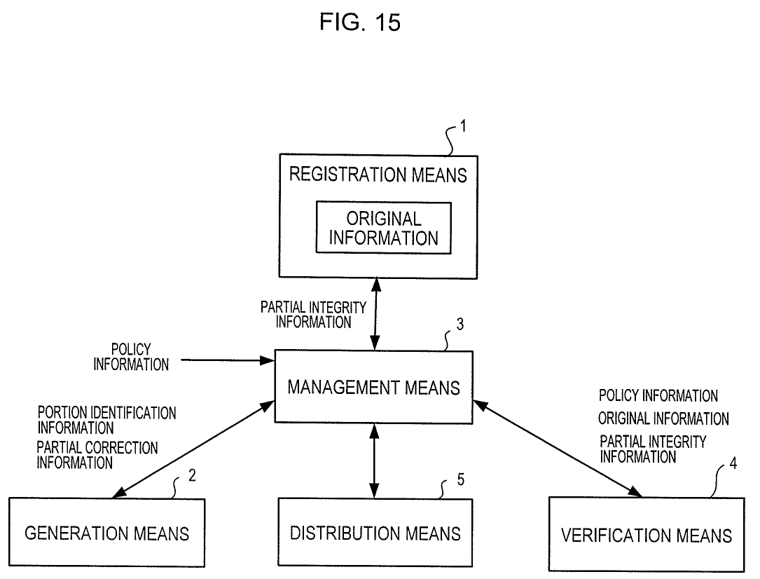

Next, an electronic signature for personal identification at the time of transmission of analysis information will be described. FIG. 14 is a diagram which shows an outline of transmission of analysis information and reception of feedback information using electronic signatures, and FIG. 15 is a block diagram which shows a configuration of an electronic document management system.

As shown in FIG. 14, the information collecting device 10 adds, to analysis information, an electronic signature as means for identifying the source of analysis information that is to be given to the marketing company, and a time stamp indicating the time of outputting by which the time is certified afterward, and sends the analysis information to the enterprise's PC 200A. Then, the enterprise's PC 200A adds feedback information having the enterprise's electronic signature added thereto, to the received analysis information, and sends this information. This electronic signature is added as personal identification to indicate that the feedback information is information made by the enterprise and that the feedback information includes the analysis information and is sent from the enterprise's PC 200A.

An electronic signature technique which meets the above described conditions is known (see WO2006/008847). This technique can prove to a third party that, even if some data is additionally written in electronic data having an electronic signature added thereto, a portion of the data to which the electronic signature is added has not been manipulated.

The electronic document management system shown in FIG. 15 includes registration means 1, generation means 2, management means 3, verification means 4, and distribution means 5.

The registration means 1 registers document information created from electronic information, as original information. The generation means 2 creates portion identification information which identifies partial correction, change, addition, deletion, and the like (hereinafter referred to as correction) which are applied to registered original information, and partial correction information which represents a history of partial correction on original information.

The management means 3 manages two types of information, portion identification information and partial correction information, as partial integrity information together with original information, and further manages this information according to policy information.

At the time of registration of original information, policy information is used as registration policy information, which describes conditions such as necessary matters (required document information) and creator authority. At the time of correction after registration of original information, policy information is used as correction policy information, which describes partial correction management control information (corrector, correctable range, uncorrectable range, and the like), procedure, constraint, condition, and the like which are predetermined for the original information. In this technique, identical information is used for correction policy information and registration information.

While a portion to be filled, a corrector, a correction operation, and a procedure are defined by an agreement or the like in the case of a contract document on paper, means for verifying operation control and its content in a similar way is also provided in the case of document information composed of electronic information.

The verification means 4 verifies that partial correction on original information is properly performed, using correction policy information and partial integrity information.

The distribution means 5 forms a transmitting/receiving unit which transmits/receives original information to distribute the original information among a plurality of entities.

Original information to be registered by the registration means 1 corresponds to a document which requires third party certification to be provided for evidentiary purposes in court (for example, a critical document such as a contract document). Registered original information is stored in the registration means 1. The portion identification information and partial correction information generated by the generation means 2 are generated to allow a corrected portion and a corrected content of original information registered in the registration means 1 to be checked afterward, and are associated with the original information. When original information stored in the registration means 1 is corrected, the old edition of the original information is preserved and a new edition thereof is created and stored. Then, partial integrity information for the new edition is generated and associated with the original information.

In the electronic document management system as described above, a corrected portion in an electronic document like the above described original document can be clearly identified to assure that partial correction has been properly corrected, and the corrected electronic document (document information) can be distributed from entity to entity Furthermore, integrity of the corrected electronic document can be assured at each time point with respect to each entity.

As described above, when information provided by an information provider is determined to be beneficial, the information provider can obtain a compensation appropriate to the information (for example, a bonus added to the basic contract rate). Accordingly, motivation for the information provider to provide beneficial information can be increased. In addition, since an information provider can get compensation appropriate to provided information, people who have not provided information for conventional marketing research are motivated to provide information, so a marketing company can obtain information from more information providers. In addition, since information is not provided to an enterprise but to the marketing company, privacy of information providers can be protected, and an enterprise can obtain averaged analysis information which is not affected by an idea fixed by the enterprise.

In addition, the marketing company can collect from an enterprise a fee for provision of analysis information. In addition, the marketing company can easily find a capable information provider for marketing research by evaluating information providers.

In addition, an enterprise does not need to have equipment and human resources for data mining, educate employees for data mining, and manage privacy information of information providers.

Further, in a computer including a display control device, a program to execute the above described steps can be provided as an information collecting program. The above described program is stored in a computer readable recording medium so that the computer including the display control device can execute the program. Such program is stored in a computer readable recording medium such as a hard disk, a flexible disk, compact disc ROM (CD-ROM), magneto-optical (MO) disk, chip card, and digital versatile disk (DVD), and executed by a computer. The program may be transmission medium distributable through a network such as Internet.

What is claimed is:

1. A computer readable recording medium on which information collecting program is recorded, the information collecting program causing a computer to execute:
a provided information accepting step of accepting provided information which is information provided from an information provider, as electronic data;
a provided information management step of associating the provided information accepted in the provided information accepting step with the information provider, and registering the provided information associated with the information provider in a table to store the provided information associated with the information provider in a database;
an analysis step of reading out the provided information stored in the database in the provided information management step and analyzing the provided information;
an analysis information management step of associating analysis information that is an analysis result of the analysis step with the provided information and registering the analysis information associated with the provided information in the table to store the analysis information associated with the provided information in the database;
an output step of outputting the analysis information stored in the database in the analysis information management step, as electronic data;
an evaluation information accepting step of accepting first evaluation information that is evaluation information of the analysis information outputted in the output step, as electronic data; and
an evaluation step of calculating second evaluation information that is evaluation information of the information provider stored in the database, based on the first evaluation information accepted in the evaluation information accepting step.

2. The computer readable recording medium on which the information collecting program is recorded according to claim 1, wherein, by the information collecting program, the evaluation step calculates third evaluation information that is evaluation information of the provided information stored in the database, based on the first evaluation information, and calculates the second evaluation information based on the third evaluation information.

3. The information collecting program according to claim 2, wherein, by the information collecting program, the provided information management step associates the information provider and the provided information which are stored in the database with second evaluation information and third information respectively, and registers the information provider associated with the second evaluation information and the provided information associated with the third information in the table to store the information provider associated with the second evaluation information and the provided information associated with the third information in the database, wherein the second evaluation information and the third information are evaluation information of the information provider and the provided information respectively.

4. The computer readable recording medium on which the information collecting program is recorded according to claim 3, wherein the information collecting program causes the computer to execute a probability calculation step of calculating a probability value of the analysis information based on the third evaluation information of the provided information stored in the database in the provided information management step corresponding to the analysis information stored in the database in the analysis information management step and the second evaluation information of the information provider corresponding to the provided information.

5. The computer readable recording medium on which the information collecting program is recorded according to claim 1, wherein, by the information collecting program, the output step adds the probability value calculated in the probability calculation step to the analysis information and outputs the analysis information with the probability value added.

6. The computer readable recording medium on which the information collecting program is recorded according to claim 1, wherein, by the information collecting program, the output step adds an electronic signature to the analysis information and outputs the analysis information with the electronic signature added.

7. The computer readable recording medium on which the information collecting program is recorded according to claim 1, wherein, by the information collecting program, the provided information accepting step accepts the provided information through a web site.

8. An information collecting device comprising:
a provided information accepting unit which accepts provided information provided from an information provider, as electronic data;
a provided information management database which associates the provided information accepted by the provided information accepting unit with the information provider and manages the provided information associated with the information provider;
an analysis unit which analyzes the provided information managed by the provided information management database;
an analysis information management database which associates analysis information that is an analysis result of the analysis unit with the provided information and manages the analysis information associated with the provided information;
an output unit which outputs the analysis information managed by the analysis information management database, as electronic data;
an evaluation information accepting unit which accepts first evaluation information that is evaluation information of the analysis information outputted from the output unit, as electronic data; and
an evaluation unit which calculates second evaluation information that is evaluation information of the information provider, based on the first evaluation information accepted by the evaluation information accepting unit.

9. The information collecting device according to claim 8, wherein the evaluation unit calculates third evaluation information that is evaluation information of the provided information based on the first evaluation information, and calculates the second evaluation information based on the third evaluation information.

10. The information collecting device according to claim 9, wherein the provided information management database associates the information provider and the analysis information with second evaluation information and third information respectively, and manages the information provider associated with the second evaluation information and the provided information associated with the third information wherein the second evaluation information and the third information are evaluation information of the information provider and the provided information respectively.

11. The information collecting device according to claim 10, further comprising a probability calculation unit which calculates a probability value of the analysis information based on the third evaluation information of the provided information managed by the provided information management database corresponding to the analysis information managed by the analysis information management database and the second evaluation information of the information provider corresponding to the provided information.

12. The information collecting device according to claim 8, wherein the output unit adds the probability value calculated by the probability calculation unit to the analysis information and outputs the analysis information with the probability value added.

13. The information collecting device according to claim 8, wherein the output unit adds an electronic signature to the analysis information and outputs the analysis information with the electronic signature added.

14. The information collecting device according to claim 8, wherein the provided information accepting unit accepts the provided information through a web site.

15. An information collecting method comprising:
a provided information accepting step of accepting provided information which is information provided from an information provider, as electronic data;
a provided information management step of associating the provided information accepted in the provided information accepting step with the information provider, and registering the provided information associated with the information provider in a table to store the provided information associated with the information provider in a database;
an analysis step of reading out the provided information stored in the database in the provided information management step and analyzing the provided information;
an analysis information management step of associating analysis information that is an analysis result of the analysis step with the provided information and registering the analysis information associated with the provided information in the table to store the analysis information associated with the provided information in the database;
an output step of outputting the analysis information stored in the database in the analysis information management step, as electronic data;
an evaluation information accepting step of accepting first evaluation information that is evaluation information of the analysis information outputted in the output step, as electronic data; and
an evaluation step of calculating second evaluation information that is evaluation information of the information provider stored in the database, based on the first evaluation information accepted in the evaluation information accepting step.

16. The information collecting method according to claim 15, wherein the evaluation step calculates third evaluation information that is evaluation information of the provided information stored in the database, based on the first evaluation information, and calculates the second evaluation information based on the third evaluation information.

17. The information collecting method according to claim 16, wherein the provided information management step associates the information provider and the provided information which are stored in the database with second evaluation information and third information respectively, and registers the information provider associated with the second evaluation information and the provided information associated with the third information in the table to store the information provider associated with the second evaluation information and the provided information associated with the third information in the database, wherein the second evaluation information and the third information are evaluation information of the information provider and the provided information respectively.

18. The information collecting method according to claim 17, further comprising a probability calculation step of calculating a probability value of the analysis information based on the third evaluation information of the provided information stored in the database in the provided information management step corresponding to the analysis information stored in the database in the analysis information management step and the second evaluation information of the information provider corresponding to the provided information.

19. The information collecting method according to claim 15, wherein the output step adds the probability value calculated in the probability calculation step to the analysis information and outputs the analysis information with the probability value added.

20. The information collecting method according to claim 15, wherein the output step adds an electronic signature to the analysis information and outputs the analysis information with the electronic signature added.
